(19) United States
(12) Patent Application Publication
(10) Pub. No.: US 2005/0262004 A1
(43) Pub. Date: Nov. 24, 2005

(54) Stock-jobbing support device and stock-jobbing support system

(76) Inventors: Hideo Sakata, Chiba (JP); Yoshie Ebe, Tokyo (JP)

Correspondence Address: BIRCH STEWART KOLASCH & BIRCH, PO BOX 747, FALLS CHURCH, VA, 22040-0747, US

(21) Appl. No.: 10/521,569

(22) PCT Filed: Jul. 18, 2003
(86) PCT No.: PCT/JP03/09173

§ 371 Date: Jan. 18, 2005

(30) Foreign Application Priority Data
Jul. 23, 2002 (JP) 2002-213663

(51) Int. Cl. G06F 17/60

(52) U.S. Cl. 705/37

(57) ABSTRACT

A stock trading support apparatus 2 to support stock trading includes: a stock price analysis information creating section (for example, a CPU 21 and the like) to create stock price analysis information by analyzing a stock price of each brand based on stock price information; a promising brand information creating section (for example, the CPU 21 and the like) to create promising brand information by judging whether the each brand is in a good time to buy or sell based on the stock price analysis information created by the stock price analysis information creating section; and an output section (for example, a display unit 23, a printing unit 25 and the like) to output stock information containing the stock price analysis information and the promising brand information.

### TECHNICAL FIELD

The present invention relates to a stock trading support apparatus and a stock trading support system, which support stock trading.

### BACKGROUND ART

On the Internet, there have been provided various information for stock trading, for example, information on a stock price of each brand, a stock chart, and the like.

Meanwhile, by experts such as securities analysts, there have been proposed various stock trading analysis methods for judging a timing for buying or selling stocks based on a trend of a stock price.

Some individual investors buy and sell stocks based on the result of analysis obtained from their own favorite stock trading analysis method among these stock trading analysis methods.

However, in stock trading based on the stock trading analysis methods as described above, it is difficult for the individual investors to judge whether the stock is in a good time to buy or sell. Even when they can judge the timing for buying or selling stocks, it has been cumbersome and troublesome to pick up a promising brand out from the whole listed brands.

The present invention has been made in view of the above-mentioned circumstances, and an object thereof is to provide a stock trading support apparatus and a stock trading support system, which support stock trading by providing an investor with information on promising brands more easily and quickly.

### DISCLOSURE OF THE INVENTION

In order to attain the above object, a first aspect of the present invention is, for example, as shown in FIGS. 1 to 16, a stock trading support apparatus 2 to support stock trading, comprising: a stock price analysis information creating section (for example, a CPU 21 and the like) to create stock price analysis information by analyzing a stock price of each brand based on stock price information; a promising brand information creating section (for example, the CPU 21 and the like) to create promising brand information by judging whether the each brand is in a good time to buy or sell based on the stock price analysis information created by the stock price analysis information creating section; and an output section (for example, a display unit 23, a printing unit 25 and the like) to output stock information containing the stock price analysis information and the promising brand information.

Here, the stock price analysis information is, for example, technical chart analysis data based on movement in stock prices, a trend line and the like; the stock price analysis information may be any analysis information as long as the information is concerned with stock trading. The promising brand information is information on brands in a good time to buy or sell, and a method of judging whether a brand is in a good time to buy or sell is not limited. The stock information contains the stock price analysis information and the promising brand information, and may contain information concerning stock trading, such as stock price numeric data and company information.

According to the first aspect of the present invention, stock price analysis information is created by the stock price analysis information creating section by analyzing a stock price of each brand based on stock price information, promising brand information is created by the promising brand information creating section by judging whether the each brand is in a good time to buy or sell based on the stock price analysis information, and stock information containing the stock price analysis information and the promising brand information is outputted by the output section. Thus, it is possible to supply the stock price analysis information and the promising brand information based on the stock price information to the users easily and quickly, to support the users in the stock trading.

Preferably, the first aspect of the present invention is connectable to a user terminal 3 through a communication network (for example, a network 5 and the like), and further comprises a stock information transmitting section (for example, the CPU 21, a communication control unit 27 and the like) to transmit the stock information to the user terminal device.

This is because it is possible to support the users in stock trading and thus to expect contribution to stimulation of stock trading, since the stock information is transmitted by the stock information transmitting section to the user terminal connected through the communication network and useful information such as the stock price analysis information and the promising brand information for stock trading can be supplied easily and quickly.

Further, in the present invention, it is preferable that the apparatus further comprises a receiving section (for example, the CPU 21, the communication control unit 27 and the like) to receive from the user terminal a search criterion for searching for promising brand information; a promising brand information search section (for example, the CPU 21 and the like)to search for promising brand information relevant to the search criterion received by the receiving section; and a transmitting section (for example, the CPU 21, the communication control unit 27 and the like) to transmit to the user terminal the promising brand information retrieved by the promising brand information search section.

This is because promising brand information desired by the user can be acquired easily and quickly, since the search criterion for searching for promising brand information is received from the user terminal by the receiving section, promising brand information relevant to the search criterion designated by the user is searched for by the promising brand information search section, and the retrieved promising brand information is transmitted to the user terminal by the transmitting section.

Moreover, in the first aspect of the present invention, it is preferable that the search criterion includes at least one of a stock type, a buy-timing or a sell-timing of a brand, a price bracket, a peak price zone or a bottom price zone of a stock price, a high price zone or a low price zone of a stock price, a scale, and the like.

Here, the stock type is an item for classifying stocks. For example, the stock type is names of exchange markets, brand types which are arbitrarily set, and the like; however, the stock type is not limited thereto. As for the stock price in the peak price zone or the bottom price zone, the peak price zone is a stock price range corresponding to a highest price zone of a certain brand in the stock prices of the past, and the bottom price zone is a stock price range corresponding to a lowest price zone thereof; however, the ranges are arbitrary. The high price zone denotes a case where the stock price is higher than the average value of the past stock prices by an arbitrary rate, and the low price zone is defined as the other way round. The ranges thereof are arbitrary. The scale is kinds of stocks such as a large capitalization stock, a medium capitalization stock and a small capitalization stock, in which the stock are classified into the large capitalization stock, medium capitalization stock, small capitalization stock and the like, based on the number of issued stock and stock trading units of a listed company.

Since the search criterion includes at least one of the stock type, the buy-timing or the sell-timing of a brand, the price bracket, the peak price zone or the bottom price zone of a stock price, the high price zone or the low price zone of a stock price, the scale, and the like, it is possible to supply promising brand information desired by the user while the targets are limited.

Furthermore, it is preferable that the first aspect of the present invention further comprises a registration section (for example, the CPU 21 and the like) to register a search criterion for searching for promising brand information, which is transmitted from the user terminal; a search section (for example, the CPU 21 and the like) to periodically search whether there is promising brand information relevant to the search criterion registered by the registration section; and a notifying section (for example, the CPU 21, the communication control unit 27 and the like) to notify, when promising brand information relevant to the search criterion is retrieved by the search section, the retrieved promising brand information to the user terminal.

Here, the search criterion is an information item for searching for relevant brand(s) by arbitrarily selecting from, for example, the stock type, the buy-timing or the sell-timing of a brand, the price bracket, the peak price zone or the bottom price zone of a stock price, the high price zone or the low price zone of a stock price, and the scale. Apart from these, there may be included an information item for searching for specific brand(s), which is, for example, the name of a brand, the name of a company, a code and the like.

Thus, the search criterion for searching for promising brand information, which is transmitted from the user terminal, is registered by the registration section, whether there is promising brand information relevant to the registered search criterion is periodically searched by the search section, and the promising brand information relevant to the search criterion is notified to the user terminal by the notifying section. Accordingly, it is possible for the users to acquire promising brand information relevant to the registered search criteria more quickly, without searching for promising brand information each time. Thus, the possibility of stock trading at an optimal timing can be increased further.

In the first aspect of the present invention, it is preferable that the stock price analysis information includes a key-shaped tendency chart.

This is because, since the key-shaped tendency chart is included in the stock price analysis information, it is possible to omit the necessity for the users to create the key-shaped tendency charts, and to refer to the key-shaped tendency chart for selection of brand(s) in stock trading and judgment of buy-timing and sell-timing.

In the first aspect of the present invention, it is preferable that the stock price analysis information includes a candlestick-shaped tendency chart, and the apparatus further comprises: a line-drawing section to draw a downward trend line based on the candlestick-shaped tendency chart of a brand judged to be in a good time to buy, among brands in the promising brand information created by the promising brand information creating section; a judging section to judge whether the brand is in a buy-turn, based on the downward trend line drawn by the line-drawing section and on candlestick-shaped tendency chart data at the good time to buy the brand judged to be in the good time to buy; and a buy-turn information notifying section to notify the user terminal of a judgment result given by the judging section, as buy-turn information.

This is because the users who are not accustomed to stock trading can easily recognize the timing of a buy-turn, since it is automatically judged whether the brand judged to be in a good time to buy is in a buy-turn or not, and the buy-turn information is notified to the user terminal by the buy-turn information notifying section.

Moreover, in the first aspect of the present invention, it is preferable that the stock price analysis information includes a candlestick-shaped tendency chart, the apparatus further comprises: a line-drawing section to draw a downward trend line based on the candlestick-shaped tendency chart of a brand judged to be in a good time to sell, among brands in the promising brand information created by the promising brand information creating section; a judging section to judge whether the brand is in a sell-turn, based on the downward trend line drawn by the line-drawing section and on candlestick-shaped tendency chart data at the good time to sell the brand judged to be in the good time to sell; and a sell-turn information notifying section to notify the user terminal of a judgment result given by the judging section, as sell-turn information.

This is because the users who are not accustomed to stock trading can easily recognize the timing of a sell-turn, since it is automatically judged whether the brand judged to be in a good time to sell is in a sell-turn or not, and the sell-turn information is notified to the user terminal by the sell-turn information notifying section.

A second aspect of the present invention is a stock trading support system where a stock trading support apparatus to support stock trading is connected to a user terminal through a communication network, wherein the stock trading support apparatus comprises: a stock price analysis information creating section to create stock price analysis information by analyzing a stock price of each brand based on stock price information; a promising brand information creating section to create promising brand information by judging whether the each brand is in a good time to buy or sell based on the stock price analysis information created by the stock price analysis information creating section; a receiving section to receive from the user terminal a search criterion for searching for promising brand information; a promising brand information search section to search for promising brand information relevant to the search criterion received by the receiving section; and a transmitting section to transmit to the user terminal the promising brand information retrieved by the promising brand information search section, and the user terminal comprises: an input section to input the search criterion; a communication section to transmit, to the stock trading support apparatus, the search criterion inputted through the input section, and receive the promising brand information transmitted by the transmitting section; and an output section to output the promising brand information received by the communication section.

According to the second aspect of the present invention, it is possible to supply the stock price analysis information and the promising brand information based on the stock price information, to the users easily and quickly through the communication network. Thus, it is possible to support the users in stock trading.

### BRIEF DESCRIPTION OF THE DRAWINGS

FIG. 1 is a block diagram depicting the entire system configuration of a stock trading support device 1 according to the present invention;

FIG. 2(a) is a block diagram showing an inner structure of a stock information support apparatus 2 shown in FIG. 1;

FIG. 2(b) is a block diagram showing an inner structure of a user terminal 3 shown in FIG. 1;

FIG. 3 is a view showing data structures in a storage unit 26 of the stock information support apparatus shown in FIG. 2;

FIG. 4 is a flow chart for explaining an operation of registration processing of the stock trading support system 1 according to the present invention;

FIG. 5 is a flow chart for explaining an operation of search processing of the stock trading support system 1 according to the present invention;

FIG. 6 is a flow chart for explaining an operation of brand information distribution processing of the stock trading support system 1 according to the present invention;

FIG. 7 is a flow chart for explaining an operation of buy-turn/sell-turn information distribution processing of the stock trading support system 1 according to the present invention;

FIG. 8 is a view showing an example of display of a search screen (G1) in the stock trading support system 1 according to the present invention;

FIG. 9 is a view showing an example of display in which selection items of a search screen (G2) are displayed;

FIG. 10 is a view showing an example of display of a search result screen (G3);

FIG. 11 is a view showing an example of display of a chart display screen (G4), which is an example of display of a key-shaped tendency chart;

FIG. 12 is a view showing an example of display of a chart display screen (G5), which is an example of display of a daily tendency chart of a candlestick-shaped tendency chart;

FIG. 13 is a view showing an example of display of a chart display screen (G6), which is an example of display of a weekly tendency chart of a candlestick-shaped tendency chart;

FIG. 14 is a view showing an example of display of a chart display screen (G7), which is an example of display of a monthly tendency chart of a candlestick-shaped tendency chart;

FIG. 15 is a view showing an example of display of a chart display screen (G8), which is an example of display of a monthly tendency chart of a candlestick-shaped tendency chart; and

FIG. 16 is a view showing an example of display of a chart display screen (G9), which is an example of display of a monthly tendency chart of a candlestick-shaped tendency chart.

### BEST MODE FOR CARRYING OUT THE INVENTION

Hereinbelow, a best mode for carrying out the invention will be described with reference to the drawings.

First, the configuration will be described.

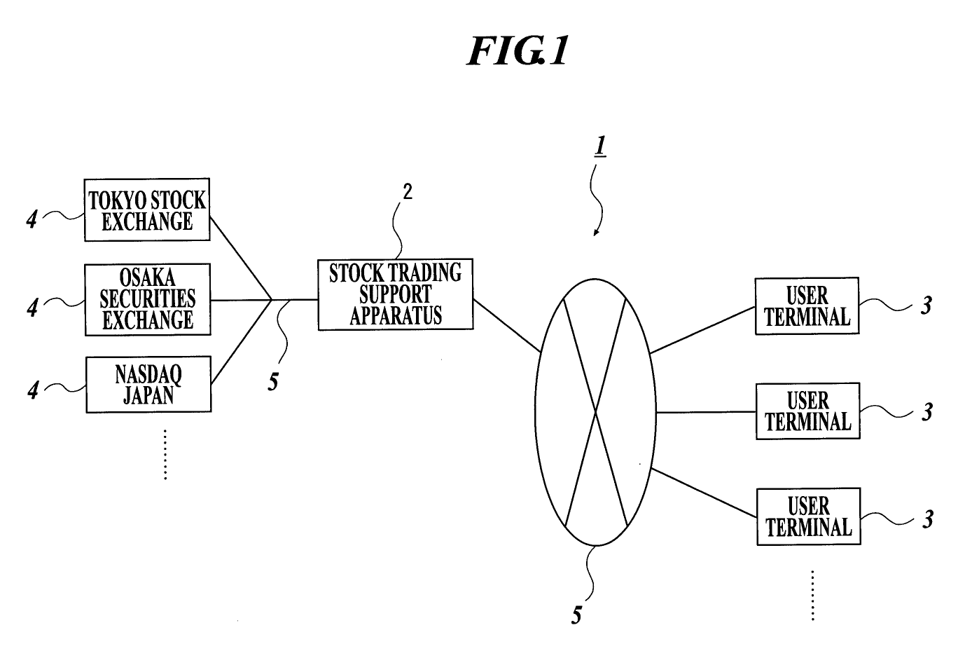

As shown in FIG. 1, a stock trading support system 1 according to the present invention includes: a stock trading support apparatus 2 which creates stock information containing information on brand(s) good to buy or sell based on stock price information, and provides the stock information to a user, thus supporting the user in stock trading; a user terminal 3 through which the user accesses the stock trading support apparatus 2 to acquire brand information; stock exchange servers 4 of such as securities exchanges, from which data on stock prices is distributed to the stock trading support apparatus 2; and the like. These are connected through networks 5 such as the Internet, an intranet, and a dedicated line.

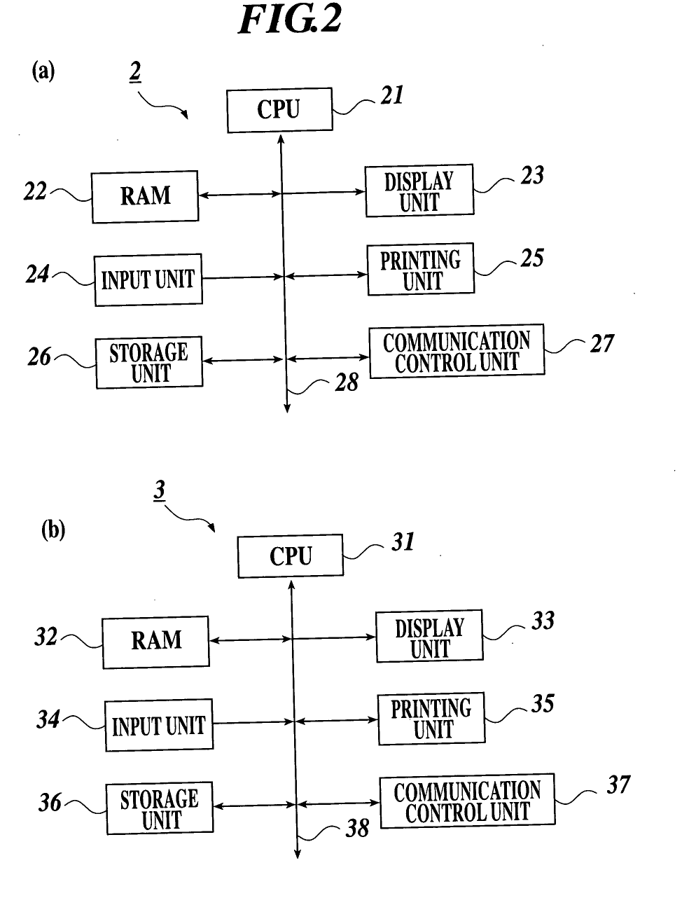

The stock trading support apparatus 2 performs processing of judging brands good for dealing and timings good for dealing based on stock price data, creates information about promising brands which are in a good time to buy or sell, and retrieves required brand information to provide it to registered users. The stock trading support apparatus 2 may be a single apparatus or include a plurality of devices. As shown in FIG. 2(a), inside the stock trading support apparatus 2, there are included a CPU 21, a RAM 22, a display unit 23, an input unit 24, a printing unit 25, a storage unit 26, and a communication control unit 27, and these units are connected through a bus 28.

The CPU 21 reads programs, data base information and the like which are stored in the storage unit 26, temporarily stores the data in the RAM 22, and performs control of each unit, data transfer, judgment processing, and the like.

For example, as a stock price analysis information creating section, the CPU 21 performs processing of updating the stock information which is to be provided to a user, based on, for example, stock price data on the listed brands transmitted from the stock-exchange servers 4, such as the Tokyo Stock Exchange, the Osaka Securities Exchange, the NASDAQ Japan, and securities exchanges of foreign countries. More specifically, the CPU 21 updates stock price information, as well as creates four kinds of technical charts, that is, a key-shaped tendency chart and candlestick-shaped tendency charts including a daily tendency chart, a weekly tendency chart and a monthly tendency chart, as needed.

Moreover, as a promising brand information creating section, the CPU 21 performs brand evaluation judgment processing based on stock price data and key-shaped tendency chart data of the past, which are accumulated in the storage unit 26, as well as up-to-date stock price data and key-shaped tendency chart data, and the like. Here, in the evaluation judgment processing that the CPU 21 performs, judgment is made on each brand about whether the brand is a promising brand which is in a good time to buy or sell, in accordance with an evaluation judgment reference table 261d to be described later. The CPU 21 provides a buy signal or sell signal to brands which are judged to be in a good time to buy or sell, respectively, to show that these brands are promising brands.

Moreover, as the evaluation judgment processing on each brand, the CPU 21 also performs classification processing of classifying brands based on a price bracket, a scale and the like, and judgment processing of judging whether the up-to-date stock price data of a brand is in a peak price zone or in a bottom price zone, or in a high price zone or a low price zone.

Here, the stock price level which corresponds to a highest price in a fluctuation in the stock price of the past is called a “peak”, and the vicinity of the level, for example, in a range of 10% from the level, is called the peak price zone. On the other hand, the stock price level which corresponds to a lowest price of the past is called a “bottom”, and the vicinity of the level, for example, in a range of 10% from the level, is called the bottom price zone. The high price zone is a level where the stock price is higher than the average of the past stock price but is not as high as a stock price in the peak price zone; the low price zone is the opposite of the high price zone.

The ranges of the above-mentioned peak price zone, bottom price zone, high price zone and low price zone can be arbitrarily set.

Further, the CPU 21 controls stock information search processing in accordance with an RDBMS (Relational Database Management System). In other words, the CPU 21 performs processing of searching the various databases stored in the storage unit 26 using SQL and the like, based on criteria transmitted from a user terminal 3 or criteria inputted from the input unit 24, and processing of acquiring relevant data. More concretely, as a receiving section, the CPU 21 receives search criteria data transmitted from the user terminal 3, for example, a stock type, buy-timing/sell-timing of a brand, a price bracket, a peak price/bottom price zone, a high price/low price zone, and a scale of a brand, or search criteria data such as a brand name, a code, and the like. Further, the CPU 21 searches for relevant brand(s) as a promising brand information search section and a search section, based on the search criteria data. The CPU 21 then transmits the retrieved brand information to the user terminal 3, as a stock information transmitting section and a transmitting section, to provide information thereto.

Moreover, as a registration section, the CPU 21 registers, for example, search criteria for searching for promising brand(s) required by a user, and, when it is judged that there are brand(s) which satisfy the criteria pre-registered by the user, the CPU 21 notifies, as a notifying section, the user of the brand information satisfying the registered criteria by transmitting the information to the user terminal 3. Furthermore, the CPU 21 controls processing of distributing, periodically or as needed, stock price information on target brand(s) pre-registered by a user.

Moreover, as a line-drawing section, the CPU 21 performs control of drawing a downward trend line based on the candlestick-shaped tendency chart of a brand which is designated by a user and to which a buy signal (buy-timing) is provided, among promising brands. Further, the CPU 21 performs control of drawing a downward trend line based on the candlestick-shaped tendency chart of a brand which is designated by a user and to which a sell signal (sell-timing) is provided, among promising brands.

Moreover, as a judging section, the CPU 21 performs control of judging whether the brand designated by the user is in a buy-turn, based on the downward trend line and the candlestick-shaped tendency chart data at the good time to buy the brand, and judging whether the brand designated by the user is in a sell-turn, based on the downward trend line and the candlestick-shaped tendency chart data at the good time to sell the brand.

Furthermore, as a buy-turn information notifying section, the CPU 21 performs control of notifying the user terminal of the judgment about whether the brand is in a buy-turn, that is, buy-turn information, and, as a sell-turn information notifying section, performs control of notifying the user terminal of the judgment about whether the brand is in a sell-turn, that is, buy-turn information.

In the various processing performed by the CPU 21, there are formed in the RAM 22 a storage region where a program, data and the like are temporarily stored, a work area used for processing in accordance with an inputted command and inputted data, and the like.

The display unit 23 is constituted by a CRT, an LCD or the like, and, as an output section, displays various display data and images which are inputted from the CPU 21.

The input unit 24 includes, for example, a mouse, a keyboard, a scanner, and the like, and desired designation information and the like can be inputted therefrom. The input unit 24 is used, for example, for update processing on various data stored in the storage unit 26.

The printing unit 25 prints out print data outputted from the CPU 21, as an output section.

Programs, data and the like are stored in the storage unit 26 in advance. The storage unit 26 includes a recording medium 26A, which is a magnetic or magneto-optical recording medium, a semiconductor memory or the like, which is readable by the CPU 21. The recording medium 26A includes a portable medium such as a CD-ROM, a memory card or the like, and a fixed medium such as a hard disk. Part of or all of the programs, data and the like stored in the storage unit 26 may be received from the communication control unit 27 from a server or the like through a network such as a WAN or a LAN. The recording medium 26A may be a recording medium of an external server constituted on a network.

Moreover, in the storage unit 26, there are stored a system program of the present invention, a relational database management system (RDBMS) (not shown), various application software such as a graphics-processing program for creating charts, various programs in which operations of the present invention are programmed, various databases, data processed by the processing programs, and the like.

The various databases stored in the storage unit 26 include an application DB 261, a stock price DB 262, a registration DB 263, and the like. These databases are, for example, a relational database or the like, and are related to each other by a brand name, a code, or the like. The CPU 21 controls information search processing on these databases and information acquisition processing in accordance with the RDBS.

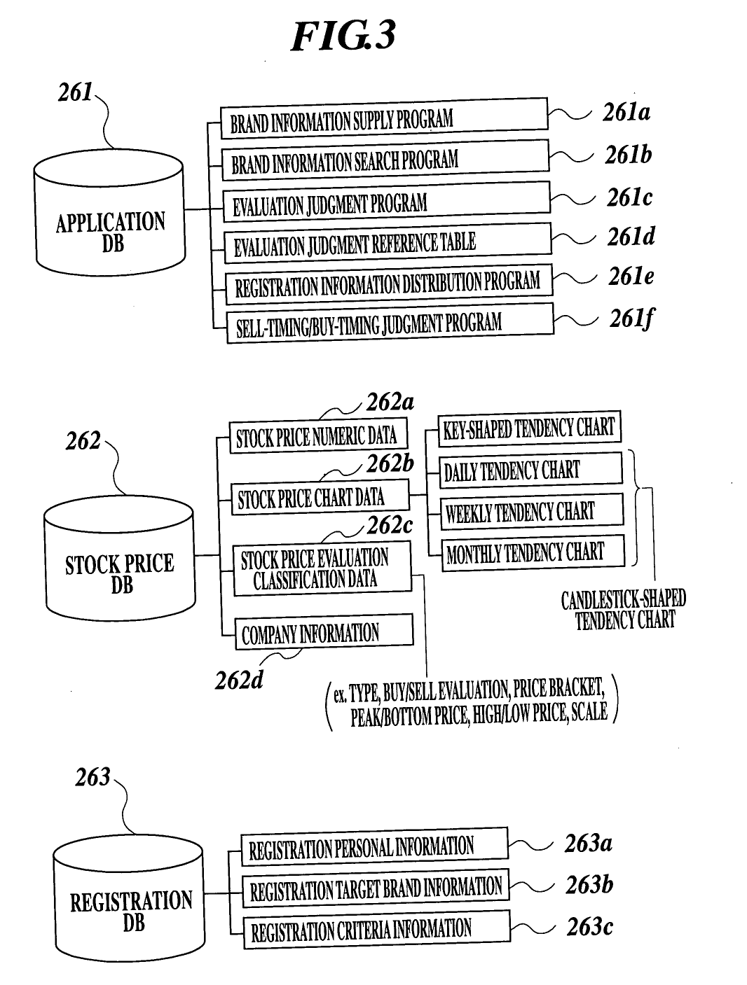

The application DB 261 is a database to store various application soft, programs and the like, which are necessary for executing operations of the present invention. More specifically, there are stored, for example, the RDBMS (not shown), technical chart creation program, main program and the like, as well as a brand information supply program 261a, a brand information search program 261b, an evaluation judgment program 261c, an evaluation judgment reference table 261d, a registration brand information distribution program 261e, a buy-turn/sell-turn information distribution processing program 261f, and the like, as shown in FIG. 3.

The CPU 21 reads a program appropriate for processing to be executed for each processing, develops the program in the RAM 22, and executes each processing in accordance with the program.

The brand information supply program 261a is a program in which there are programmed a series of operations of supplying to a user terminal 3 brand information required by the user.

The brand information search program 261b is a program for searching for brand(s) relevant to arbitrary criteria designated by a user. For example, search criteria for searching for arbitrary brand(s) include: a stock type such as a name of a stock market (for example, the TSE, the OSE, the NSE, and the like); a buy-timing/sell-timing; a price bracket; a peak price/bottom price zone; a high price/low price zone; a scale; and the like, and search criteria for searching for predetermined brands include a brand name, a code number, and the like.

The evaluation judgment program 261c is a program for performing judgment and classification concerning stock price information for each brand by comparing up-to-date stock price information transmitted from stock exchange server(s) 4 with data in the evaluation judgment reference table 261d. More concretely, for example, the evaluation judgment program 261c is used for processing of judging whether a certain brand is in a good time to buy or sell based on up-to-date stock price numeric data, technical charts such as a key-shaped tendency chart and a candlestick-shaped tendency chart, and the like, and performs classification processing for all brands to classify the up-to-date stock prices into the peak price zone, high price zone, bottom price zone, low price zone, or the like. Based on the evaluation judgment program 261c, promising brand information, which is information on brand(s) in a good time to buy or sell, is created.

The evaluation judgment program is not limited to the above. For example, the program may be one in which there is programmed an arbitrary stock trading analysis method proposed by an expert or the like such as securities analysts.

The evaluation judgment reference table 261d is reference data for performing evaluation on each brand in accordance with the above-mentioned evaluation judgment program 261c. For example, the evaluation judgment reference table is predetermined criteria data for judging which brand is good to buy or sell based on a pattern of shape of a key-shaped tendency chart, and the like.

It goes without saying that the criteria data in the evaluation judgment reference table 261d varies according to the stock trading analysis method.

The brand information distribution program 261e is a program for distributing to a user terminal 3 information on brand(s) relevant to criteria pre-registered by the user. Here, the pre-registered criteria are, for example, a name of a stock market, a price bracket, a scale, a peak price/bottom price zone, a high price/low price zone, a buy-timing/sell-timing, and the like.

The distribution processing is performed every time the stock price data is updated, for example. In a case where a user has registered a predetermined brand as a target brand based on the program 261e, processing of periodically distributing stock price information on the registered target brand or distributing information when target brand has satisfied a predetermined condition can be executed.

The buy-turn/sell-turn information distribution processing program 261f performs processing of drawing a trend line based on the candlestick-shaped tendency chart of a brand designated by a user to judge whether the brand is in a sell-turn or buy-turn, and transmitting the result to the user terminal 3.

The stock price DB 262 is a database to store stock price data transmitted from the stock exchange servers 4. In the stock price DB 262, there are stored, for example, old and up-to-date stock price numeric data 262a, stock price chart data 262b, stock price evaluation classification data 262c, company information 262d, and the like, and the data are related to each other for each brand.

Here, the stock price numeric data 262a is stock price data on each brand distributed from the stock exchange servers 4. Technical charts are created based on accumulated stock price data and up-to-date stock price data in the stock price numeric data 262a, and brands are evaluated and classified. The stock price chart data 262b includes technical charts that are diagrams showing changes in the stock price of each brand. There are four types of technical charts, namely, a key-shaped tendency chart and a candlestick-shaped tendency chart including a daily tendency chart, a weekly tendency chart and a monthly tendency chart. The data thereof is updated in accordance with update of the stock price numeric data.

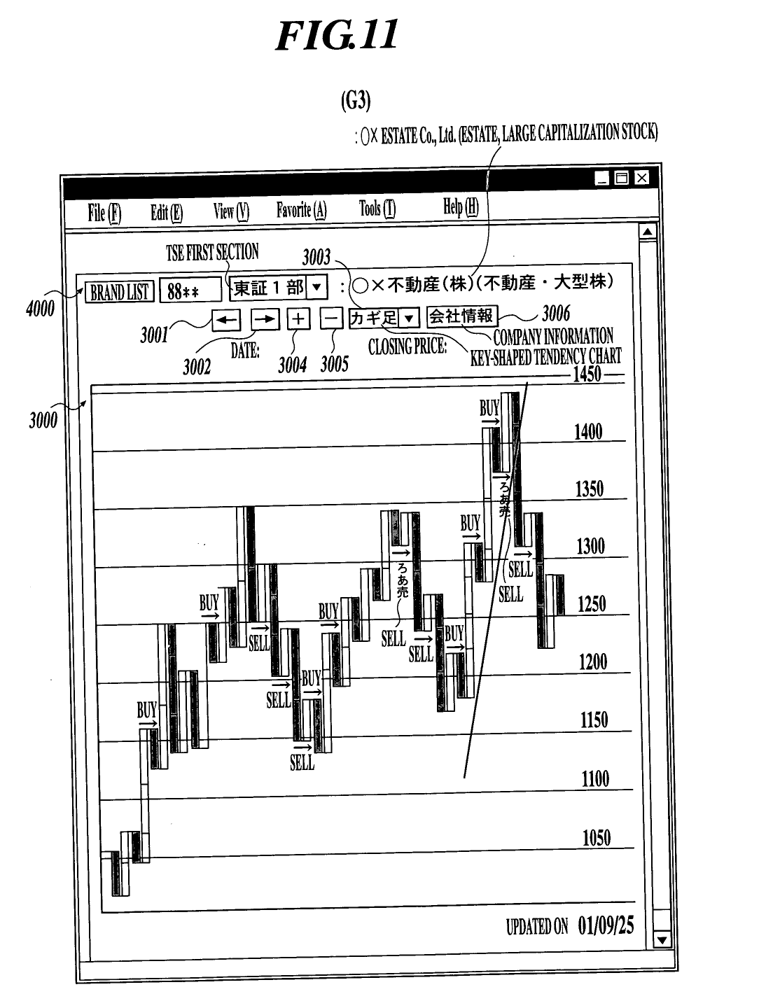

Here, the key-shaped technical chart is, for example, a diagram as shown in FIG. 11, in which negative and positive bar lines are drawn based on a predetermined reference fluctuation range of a stock price. No bar line is drawn when the stock price is fluctuated within the predetermined range, a positive bar line (white bar line) is drawn when the stock price is increased by or more than the reference fluctuation range, and a negative bar line (black bar line) is drawn when the stock price is decreased by or more than the reference fluctuation range. As an alternative to the reference fluctuation range, a fluctuation rate (up-down rate) may be used. When the key-shaped tendency chart thus created satisfies a certain condition based on the evaluation judgment reference table 261d, a buy signal, a sell signal and the like are generated and displayed on the key-shaped tendency chart.

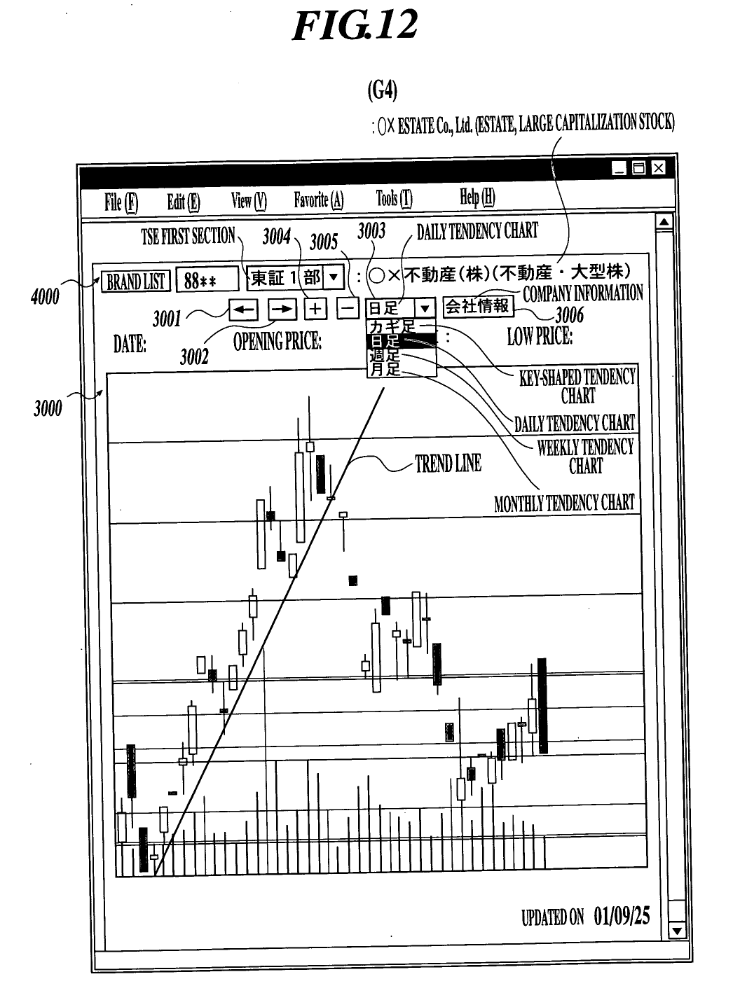

Examples of the candlestick-shaped tendency chart as a technical chart are diagrams as shown in FIGS. 12 to 16. To draw a bar line called a body from the position of an opening price to the position of a closing price of a stock, a positive bar line is drawn when the closing price is higher than the opening price, and a negative bar line is drawn when the closing price is lower than the opening price. For price movement in a continuous session, price movement outside the range from the opening price to the closing price is expressed by a solid line called a “shadow” or a “whisker”. From the candlestick-shaped tendency chart, there can be read, for example, that the market is a bear market when negative bar lines continue, and that the market is a bull market when positive bar lines continue.

The stock price evaluation classification data 262c include: evaluation data such as a buy-timing and a sell-timing evaluated in accordance with the evaluation judgment program 261c; and classification data such as a price bracket, a scale, and a peak price zone, and these data are updated in accordance with update of the stock price numeric data. Moreover, processing of searching for arbitrary brands is performed based on the stock price evaluation classification data 262c.

The registration DB 263 is a database to store registration information of registered users to whom stock information is distributed. More specifically, there are stored data on such as registration personal information 263a, registration target brand information 263b, and registration criteria information 263c.

The registration personal information 263a is personal information data on users who have registered as clients to the stock trading support apparatus 2 to receive services such as a stock price browser service and an information distribution service. The registration personal information 263a include, for example, contact information on the clients, registration number data, password data, and the like.

The registration target brand information 263b is information on target brands designated by the registered users. The registration target brand information 263b is set, for example, such that stock price information on the registered target brand(s) is promptly supplied upon accessing from the user to the stock trading support apparatus 2.

The registration criteria information 263c is arbitrary search criteria data on brands, which is designated and registered by the users. The stock trading support apparatus 2 searches for relevant brand information based on the registration criteria information, and distributes the retrieved brand information to the user terminal 3 of a registered user.

The communication control unit 27 is a modem, a terminal adopter, a router or the like, and performs control for communication with an external device through a communication line such as a telephone line, an ISDN line, or a dedicated line.

Each of the user terminals 3 is a terminal device of a customer, which receives stock information by accessing the stock trading support apparatus 2, and is a general-purpose personal computer, a PDA, a mobile phone, a PHS (Personal Handyphone System), or the like. As shown in FIG. 2(b), a user terminal 3 includes a CPU 31, a RAM 32, a display unit 33, an input unit 34, a printing unit 35, a storage unit 36, and a communication control unit 37, and these units are connected through a bus 38.

Each of the above units constituting a user terminal 3 performs a similar function to that of the corresponding unit of the stock trading support apparatus 2, and thus detail descriptions thereof are omitted.

Among them, as a communication section, the CPU 31 transmits search information inputted through the input unit 34, to the stock trading support apparatus 2 through the communication control unit 37, receives stock information containing promising brand information transmitted from the stock trading support apparatus 2, and displays the information on the display unit 33. The input unit 34 is used as an input section for setting and inputting search criteria data as desired.

The display unit 33 and the printing unit 35 perform output processing in which various images are displayed and printed, in accordance with control by the CPU 31, as output sections.

Each of the stock exchange servers 4 is a server provided in a market where securities such as stocks are traded, which transmits stock price information to the stock trading support apparatus 2. The stock exchange servers 4 and the stock information supply apparatus 2 are connected via networks 5 such as a dedicated line.

Next, an operation of the present embodiment in the stock information supply system 1 configured as described above will be explained.

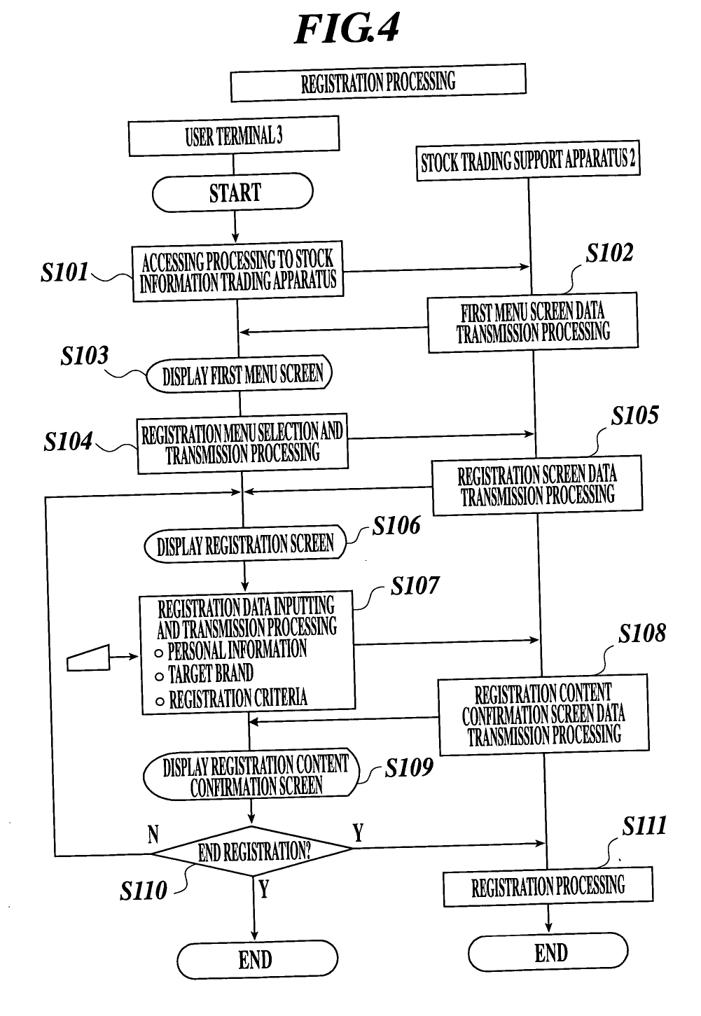

First, registration processing in which a user registers to the stock trading support apparatus 2 as a client will be explained with reference to the flow chart in FIG. 4.

A user terminal 3 is connected to the stock trading support apparatus 2 through a network 5 when a predetermined URL or the like is inputted by the operator of the user terminal 3 (Step S101).

Subsequently, the CPU 21 of the stock trading support apparatus 2 reads first menu screen data from the storage unit 26, and transmits the data through the communication control unit 27 to the user terminal 3 that has accessed the stock trading support apparatus 2 (Step S102).

Then, through the communication control unit 37, the CPU 31 of the user terminal 3 receives the first menu screen data transmitted from the stock trading support apparatus 2, temporarily stores the data in the RAM 32, and displays the first menu screen (not shown) on the display unit 33 (Step S103).

Various menu items for stock information supply are displayed on this first menu screen (not shown). The operator of the user terminal 3 selects a “registration menu” (not shown) using the input unit 34, and the data is transmitted to the stock trading support apparatus 2 (Step S104).

Subsequently, based on the selection signal of the “registration menu” transmitted from the user terminal 3, the CPU 21 of the stock trading support apparatus 2 reads registration screen data from the storage unit 26, and transmits the registration screen data to the user terminal 3 (Step S105).

Then, the CPU 31 of the user terminal 3 displays the registration screen (not shown) on the display unit 33, based on the registration screen data transmitted from the stock trading support apparatus 2 (Step S106).

When processing of inputting registration data is performed by the operator of the user terminal 3 through the input unit 34, the CPU 31 transmits the inputted registration data to the stock trading support apparatus 2 (Step S107).

Here, the inputted registration data is personal information on the user, target brand(s), registration criteria, and the like. The personal information is data on such as contact information of the user, a registration number, and a password. The information on the target brand(s) is names, codes and the like of the brands which the user is particularly interested in. Stock price information on the brands registered as target brands can be displayed immediately, without performing search processing one by one. The registration criteria is criteria information on brands of which stock price information is required by the user to be transmitted from the stock trading support apparatus 2, namely, a name of a trading market, a buy-timing or sell-timing, a price bracket, and the like. Brand information relevant to the registration criteria is retrieved by the stock trading support apparatus 2 as appropriate, and transmitted to the user terminal 3. Brand information distribution processing thus performed will be described in detail later.

Subsequently, the CPU 21 of the stock trading support apparatus 2 receives the above-mentioned registration data from the user terminal 3, creates registration content confirmation screen data based on the content of the registration, and transmits the data to the user terminal 3 (Step S108).

Then, the CPU 31 of the user terminal 3 temporarily stores the registration content confirmation screen data in the RAM 32 transmitted from the stock trading support apparatus 2, and displays a registration content confirmation screen (not shown) on the display unit 33 (Step S109). Here, in the registration content confirmation screen, registration content information which is designated and inputted by the user in Step S107 is contained.

The operator of the user terminal 3 checks the registration content confirmation screen on the display unit 33 (Step S110), and, when the operator wants to finish the registration (Step S110: Yes), for example, the operator designates a “registration button” (not shown) or the like, and the data is transmitted to the stock trading support apparatus 2.

Meanwhile, when the operator wants to change the registration content (Step S110: No), the process returns to Step S106. To cancel registration, the operator of the user terminal 3 finishes the registration by designating a cancel button (not shown) or the like.

Subsequently, in Step S111, when the CPU 21 of the stock trading support apparatus 2 has received a registration O.K. signal from the user terminal 3, the CPU 21 stores the transmitted registration data in the registration DB 263 of the storage unit 26 for registration processing, and thus the processing is finished.

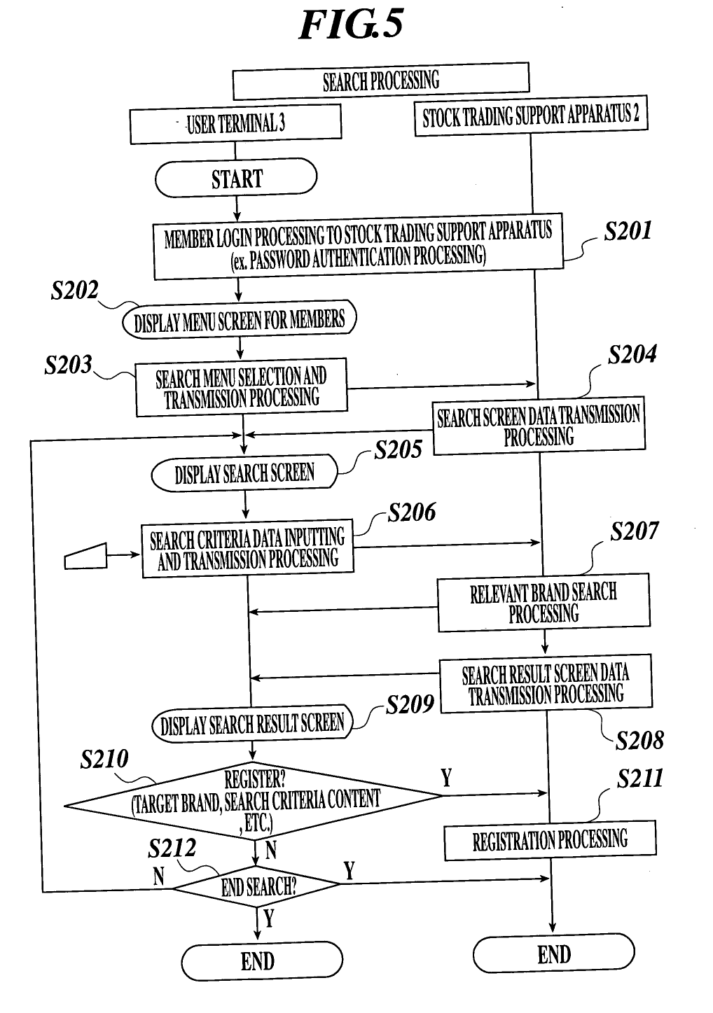

Next, stock information search processing performed between the stock trading support apparatus 2 and the user terminal 3 operated by the user registered as a client will be explained with reference to the flow chart in FIG. 5.

First, the operator of the user terminal 3 performs connection processing to the stock trading support apparatus 2 as in Step S101 in FIG. 4 by a predetermined operation, and inputs the registration number or the password set in the registration processing. The CPU 31 of the user terminal 3 transmits the inputted data to the stock trading support apparatus 2. The stock trading support apparatus 2 performs authentication processing of the registration number or the password transmitted from the user terminal 3 (Step S201).

When the above authentication processing is successful, the stock trading support apparatus 2 reads the brand information supply program 261a from the application DB 261 of the storage unit 26, develops the program in the RAM 22, and performs the following operation in accordance with the brand information supply program 261a.

First, the CPU 21 of the stock trading support apparatus 2 transmits menu screen data for members to the user terminal 3. The menu screen for members (not shown) is displayed on the display unit 33 by control of the CPU 31 of the user terminal 3 (Step S202).

In the menu screen for members (not shown), there are various menus available to the members. A “search menu” (not shown) is selected by the operator of the user terminal 3, and the data is transmitted to the stock trading support apparatus 2 (Step S203).

The CPU 21 of the stock trading support apparatus 2 receives the selection signal of the “search menu” from the user terminal 3, reads search screen data from the storage unit 26, and transmits the search screen data to the user terminal 3 (Step S204).

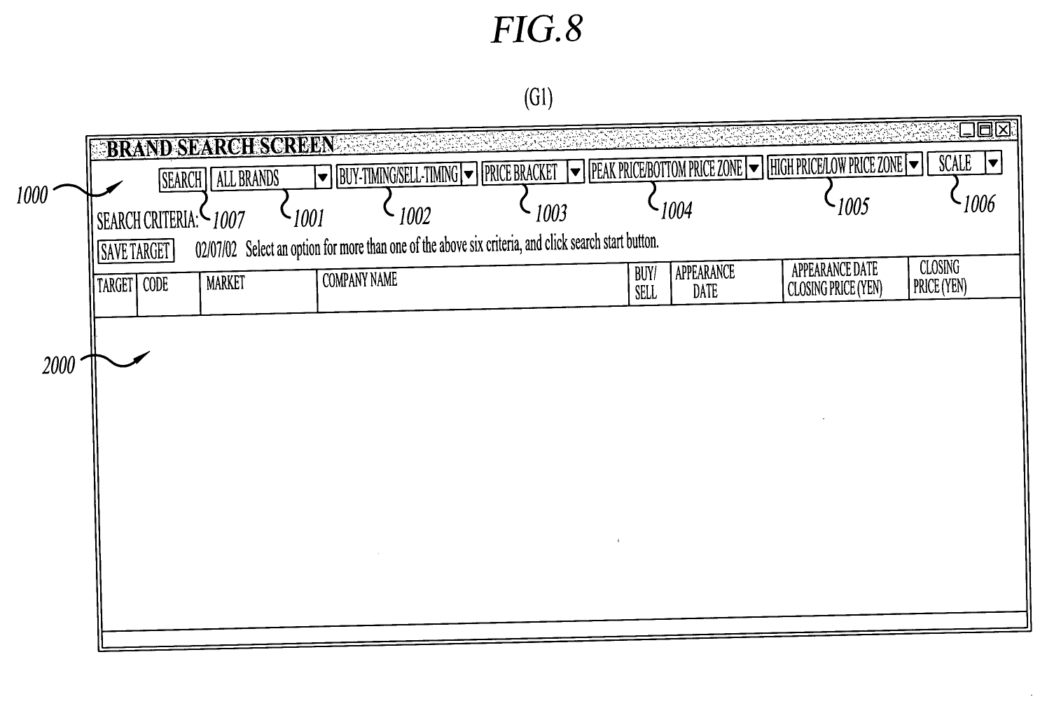

Then, the CPU 31 of the user terminal 3 displays a search screen G1 as shown in FIG. 8, on the display unit 33 (Step S205).

A search criteria selection part 1000 for searching for brand information required by the user is provided in the search screen G1 shown in the drawing. The search criteria selection part 1000 includes, as criteria items, a stock type 1001, a buy-timing/sell-timing 1002, a price bracket 1003, a peak price/bottom price zone 1004, a high price/low price zone 1005, and a scale 1006.

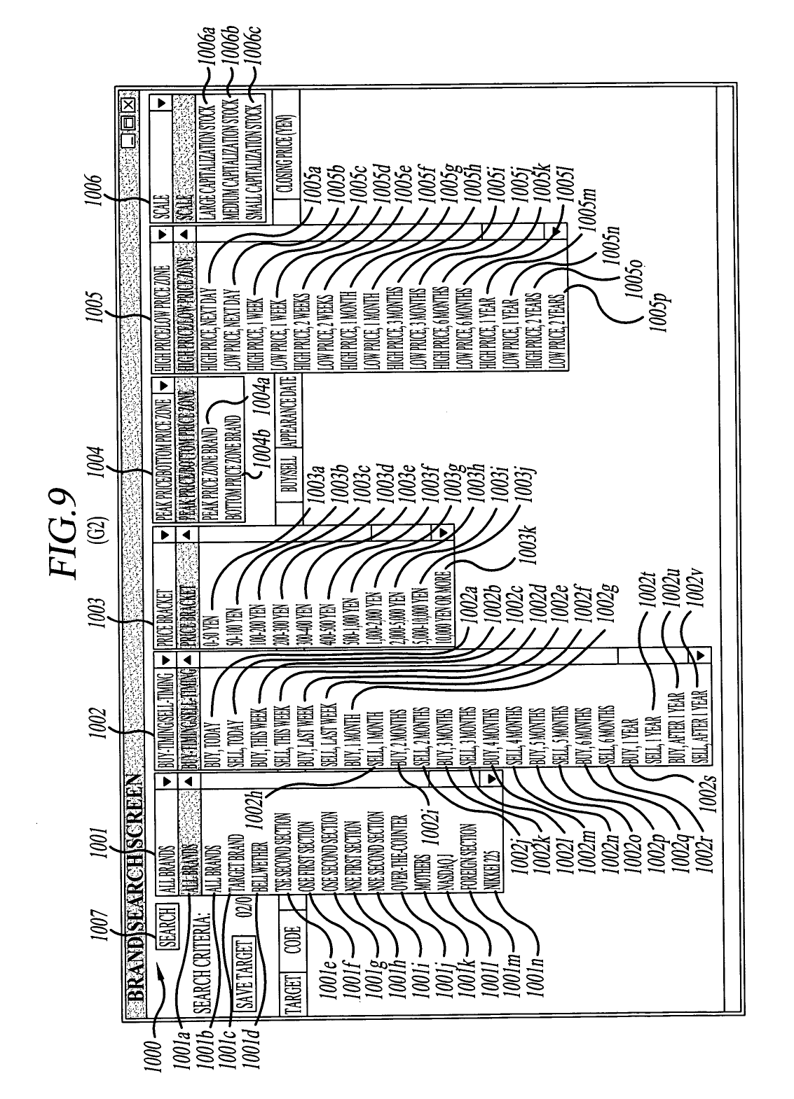

Options are provided for each of the above criteria items, as shown in a brand search screen (G2) in FIG. 9.

For example, the “stock type” 1001 is an item for selecting a type of stock(s) to be searched for. Examples of the options thereof include “all brands” 1001a, “target brand” 1001b which is pre-registered by the user, “bellwether” 1001c for displaying a bellwether stock, “TSE (Tokyo Stock Exchange) first section” 1001d, “TSE second section” 1001e, “OSE (Osaka Securities Exchange) first section” 1001f, “OSE second section” 1001g, “NSE (Nagoya Stock Exchange) first section” 1001h, “NSE second section” 1001i, “over-the-counter” 1001j, “Mothers” 1001k, “NASDAQ J (Japan)” 1001l, “foreign section” 1001m, “Nikkei 225” 1001n, and the like.

The “buy-timing/sell-timing” 1002 is an item for searching for promising brand(s) which have been judged by the stock trading support apparatus 2 as in a good time to buy or sell. Predetermined unit periods are set to the buy-timings and sell-timings. “Buy, today” 1002a specifies brand(s) which are good to buy today, “buy, this week” 1002b specifies brand(s) which are good to buy this week, and the unit periods last week, 1 month, and the like are applied likewise. More specifically, the buy-timings and sell-timings include: the “buy, today” 1002a; “sell, today” 1002b; the “buy, this week” 1002c; “sell, this week” 1002d; “buy, last week” 1002e; “sell, last week” 1002f; “buy, 1 month” 1002g; “sell, 1 month” 1002h; “buy, 2 months” 1002i; “sell, 2 months” 1002j; “buy, 3 months” 1002k; “sell, 3 months” 1002l; “buy, 4 months” 1002m; “sell, 4 months” 1002n; “buy, 5 months” 1002o; “sell, 5 months” 1002p; “buy, 6 months” 1002q; “sell, 6 months” 1002r; “buy, 1 year” 1002s; “sell, 1 year” 1002t; “buy, after 1 year” 1002u; “sell, after 1 year” 1002v; and the like.

The “price bracket” 1003 is an item for specifying a price bracket of a single stock of a brand. More specifically, there are included “0 (inclusive)-(less than) 50 yen ” 1003a, “50 (inclusive)-(less than) 100 yen ” 1003b, “100-200 yen” 1003c, “200-300 yen” 1003d, “300-400 yen” 1003e, “400-500 yen” 1003f, “500-1000 yen” 1003g, “1000-2000 yen” 1003h, “2000-5000 yen” 1003i, “5000-10000 yen” 1003j, “10000 yen or more” 1003k, and the like.

The “peak price/bottom price zone” 1004 is an item for searching for brand(s) having a stock price in a peak price zone or a bottom price zone. More specifically, there are options including “peak price zone brand” 1004a and “bottom price zone brand” 1004b.

The “high price/low price zone” 1005 is an item for searching for brand(s) having a stock price in a high price zone or a low price zone. For example, there are included: “high price, next day” 1005a, which indicates a next day of a day when the stock price of a brand has reached a high price in a certain period; “low price, next day” 1005b, which indicates a next day of a day when the stock price of a brand has reached a low price in a certain period; and “high price, 1 week” 1005c, which indicates one week after the stock price of a brand has reached a high price. Likewise, the options also include “low price, 1 week” 1005d, “high price, 2 weeks” 1005e, “low price, 2 weeks” 1005f, “high price, 1 month” 1005g, “low price, 1 month” 1005h, “high price, 3 months” 1005i, “low price, 3 months” 1005j, “high price, 6 months” 1005k, “low price, 6 months” 1005l, “high price, 1 year” 1005m, “low price, 1 year” 1005n, “high price, 2 years” 1005o, “low price, 2 years” 1005p, and the like.

The “scale” 1006 is an item concerning scales of stocks, and examples of the options thereof include “large capitalization stock” 1006a, “medium capitalization stock” 1006b, “small capitalization stock” 1006c, and the like.

With the search criteria selection part 1000 thus provided, search can be limited by selecting necessary criteria items. Search criteria data is transmitted to the stock trading support apparatus 2 when a “search” button 1007 is designated by clicking or the like, and thus limit search can be requested.

In the search screen G1, a search result part 2000 is provided under the search criteria selection part 1000. On the search screen G1 thus arranged, the operator of a user terminal 3 inputs search criteria using the input unit 34, and performs transmission processing (Step S206).

More specifically, the user selects desired criteria items among those in the search criteria selection part 1000 by using the input unit 34, and designates the “search” button 1007. The search criteria data is then transmitted to the stock trading support apparatus 2 though the CPU 31 of the user terminal 3.

Here, it is assumed, for example, that the criteria specified at the user terminal 3 are: the “TSE first section” 1001c for the “stock type” 1001; the “buy, last week” 1002e for the “buy-timing/sell-timing” 1002; the “500-1000 yen” 1003g for the “price bracket” 1003; and the “bottom price zone brand” 1004b for the “peak price/bottom price zone” 1004.

Then, the CPU 21 of the stock trading support apparatus 2 reads the brand information search program 261b to develop the program in the RAM 22, and retrieves brand information (promising brand information) satisfying the search criteria designated by the user (Step S207) by searching the stock price DB 262 in accordance with the program 261b.

Various information on brand(s) satisfying the criteria is read from the stock price DB 262, and the search result screen data is created to be transmitted to the user terminal 3 (Step S208).

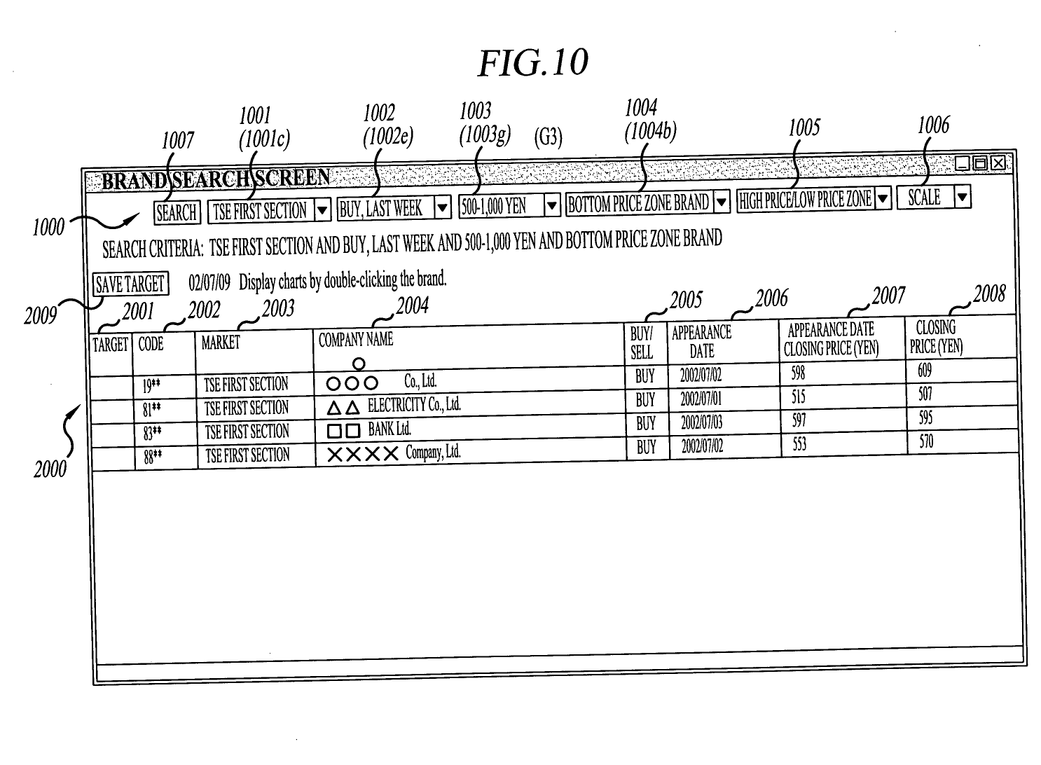

Then, a search result screen G3 as shown in FIG. 10 is displayed on the display unit 33 by control of the CPU 31 of the user terminal 3.

As shown in FIG. 10, a list of brands satisfying the search criteria is displayed in the search result part 2000. In addition, in the search result part 2000, included as items for displaying the brand information (promising brand information) of the search result are: target 2001; code 2002; market 2003; company name 2004; buy/sell 2005; appearance date 2006; appearance date closing price 2007; closing price 2008; and the like.

The target 2001 is an item for showing whether the brand is registered as a target brand by the user. If the brand is a target brand, a circle is displayed therein. The code 2002 is an ID number of the brand used in the stock market, the market 2003 is the name of a trading market of the brand, and the company name 2004 is a company name of the target brand. The buy/sell 2005 shows whether the brand is in a good time to buy or sell, the appearance date 2006 is a date when a buy signal or sell signal has appeared, the appearance date closing price 2007 is a closing price on the day when the above signal has appeared for the brand, and the closing price 2008 is an up-to-date closing price from the day when the search is performed.

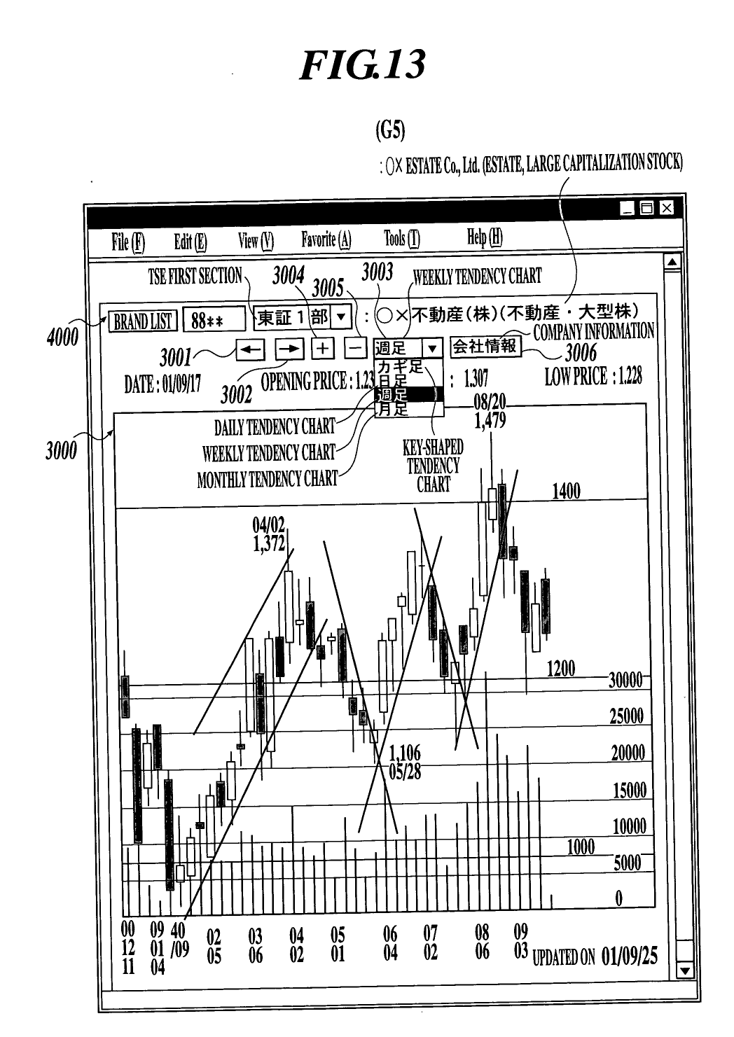

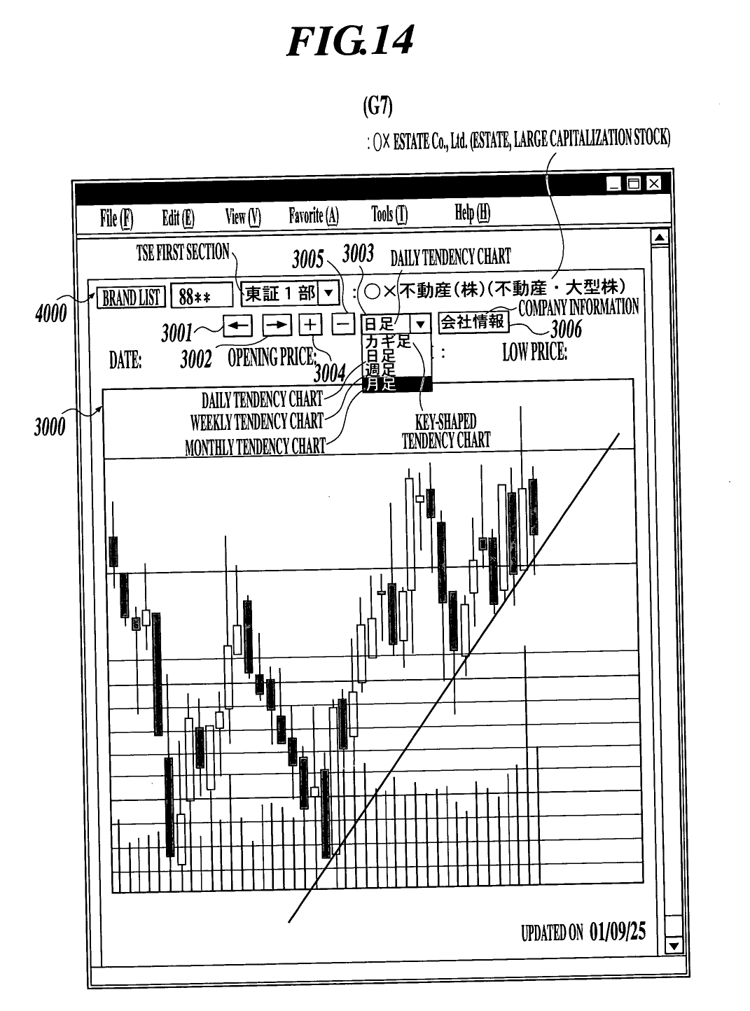

When the user double-clicks, for example, one of the codes or company names, to select a brand from those in the search result displayed in the search result part 2000, chart screens G4 to G7 are displayed as shown in FIGS. 11 to 14. The chart screens can display four types of charts, namely, a key-shaped tendency chart (FIG. 11: G4) and candlestick-shaped tendency charts including a daily tendency chart (FIG. 12: G5), a weekly tendency chart (FIG. 13: G6) and a monthly tendency chart (FIG. 14: G7), which are technical charts as stock price analysis information on the brand. In each of the chart screens G4 to G7, there is a brand information part 4000 above a chart display part 3000, to display information on the brand for which the chart is created.

With regard to the chart displayed on the chart display part 3000, charts for the last five years can be displayed by designating an arrow button 3001 or 3002.

Moreover, through a chart selection part 3003, it is possible to specify which chart among the key-shaped tendency chart, daily tendency chart, weekly tendency chart and monthly tendency chart of the candlestick-shaped tendency chart is displayed on the chart display part 3000.

In addition, the size of the chart can be enlarged and reduced by designating a zoom-in button and zoom-out button 3004 and 3005, respectively.

Moreover, by clicking a mouse or the like, which is the input unit 34 of the operator of a user terminal 3, a trend line necessary for brand selection can be drawn on the chart. Furthermore, when the mouse is positioned at an arbitrary part of the key-shaped tendency chart or the candlestick-shaped tendency chart, the date and the stock price are displayed immediately.

Moreover, when a company information button 3006 is designated, company information on the brand is displayed. Ways for displaying the company information may be to link to the homepage of the company, or to display up-to-date information on the final accounts of the company stored in the storage unit 26.

After browsing the stock information such as the search result screen G3, the chart screen G4 and the like as described above, when the user wants to register the search result brands as target brands, or registers the search criteria as registration criteria (Step S210: Yes), by designating a “registration button” 2009, the registration content data is transmitted to the stock trading support apparatus 2 by the CPU 31, and registration processing is performed by the stock trading support apparatus 2 (Step S211).

In contrast, when the user does not register the data (Step S210: No), the process moves to Step S212.

Here, in the registration processing, for example, it is possible to register the target brands by designating the “save target” button 2009 in the search result screen G3 in FIG. 10. When the target brands are registered, information on the registered brand is distributed to the user terminal 3 by the stock trading support apparatus 2. Similarly, when arbitrary criteria for brand search are registered, brand information satisfying the criteria is distributed to the user terminal 3 by the stock trading support apparatus 2.

In Step S212, the operator of the user terminal 3 selects whether to finish the search or not. When the operator has chosen to finish the search (Step S212: Yes) the processing is completed, and when the operator has chosen not to finish (Step S212: No), the process returns to Step S205.

According to the search processing in Steps S201 to S212, users can easily search for information on brand(s) which are in a good time to buy or sell, without analyzing difficult technical charts or various factors concerning stock price movement, which is very convenient for the users. Moreover, since key-shaped and candlestick-shaped tendency charts as well as company information and the like are supplied to the users, the users can judge and check the timing to buy or sell stocks of the brands from various points of view, which is convenient for the users.

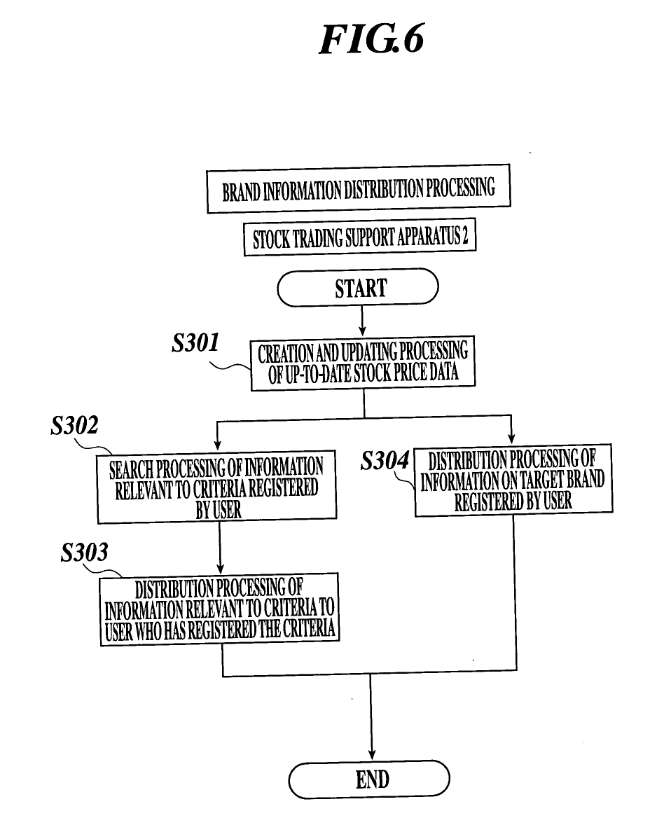

Next, with reference to the flowchart in FIG. 6, a description will be given of processing of distributing information on brand(s) satisfying criteria pre-registered by users.

First, when up-to-date stock price information is distributed from the stock exchange server(s) 4, the stock trading support apparatus 2 stores the up-to-date stock price information in the stock price DB 262, and performs processing of updating stock price data, updating charts and of evaluating brands based on the up-to-date stock price information, to create stock information (Step S301).

Here, it is assumed that the up-to-date stock price information is distributed from the stock exchange servers 4 at least once per day.

The stock trading support apparatus 2 updates stock price information to be supplied to user terminal(s) 3 in accordance with the evaluation judgment program 261c, and performs processing of creating up-to-date technical charts. Moreover, based on the up-to-date stock price information and the evaluation judgment reference table 261d, the stock trading support apparatus 2 re-performs processing of judging whether the brands are in a good time to buy or sell, and classifying the brands into criteria such as peak price/bottom price zone and high price/low price zone, to create stock information. The stock information is stored in the stock price DB 262.

Subsequently, the CPU 21 of the stock trading support apparatus 2 performs the following information distribution processing in accordance with the registration information distribution program 261e.

That is, the CPU 21 of the stock trading support apparatus 2 searches the stock price DB 262 (Step S302), performs processing of updating stock price information and then processing of judging whether there is information on brand(s) satisfying the criteria registered by users, and distributes relevant brand information (promising brand information) to the user terminal(s) 3 of users who have registered the brand(s), to notify the users (Step S303). Here, ways for distribution to the user terminals 3 are, for example, e-mailing and the like, and, when a user terminal 3 is a mobile communication terminal such as a PDA and a mobile phone, immediacy is increased.

Moreover, the CPU 21 of the stock trading support apparatus 2 creates up-to-date stock price information on target brands registered through user terminals 3, and transmits the information to the user terminals 3 (Step S304).

The above processing of distributing brand information to user terminals 3 may be performed any number of times.

In this way, information on brand(s) satisfying criteria registered by the users is distributed when the stock price information is updated, and therefore, the percentage of stock trading at an optimal timing is dramatically increased.

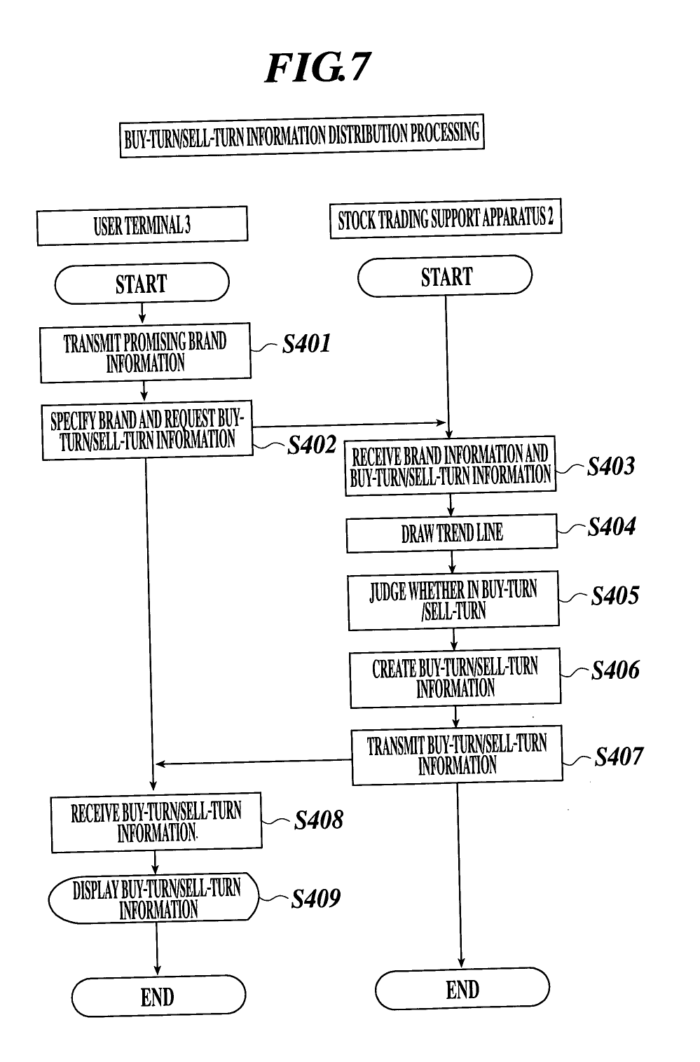

Next, with reference to the flowchart in FIG. 7, a description will be given of processing of distributing buy-turn/sell-turn information performed between the stock trading support apparatus 2 and the user terminals 3 operated by users registered as clients.

First, the communication control unit 37 of a user terminal 3 receives brand information (promising brand information) transmitted in Step S207 in FIG. 5 (Step S401), and the CPU31 displays the received brand information on the display unit 33.

Subsequently, when the user of the user terminal 3 specifies desired brand(s) among those in the displayed brand information and gives a buy-turn/sell-turn information request command (Step S402), the CPU 31 transmits the specified brand information and the buy-turn/sell-turn information request information to the stock trading support apparatus 2.

The communication control unit 27 of the stock trading support apparatus 2 receives the specified brand information and the buy-turn/sell-turn information request information (Step S403) from the user terminal 3.

The CPU 21 of the stock trading support apparatus 2 executes the buy-turn/sell-turn information distribution program 261f, to draw an upward trend line or a downward trend line for the specified brand(s) (Step S404).

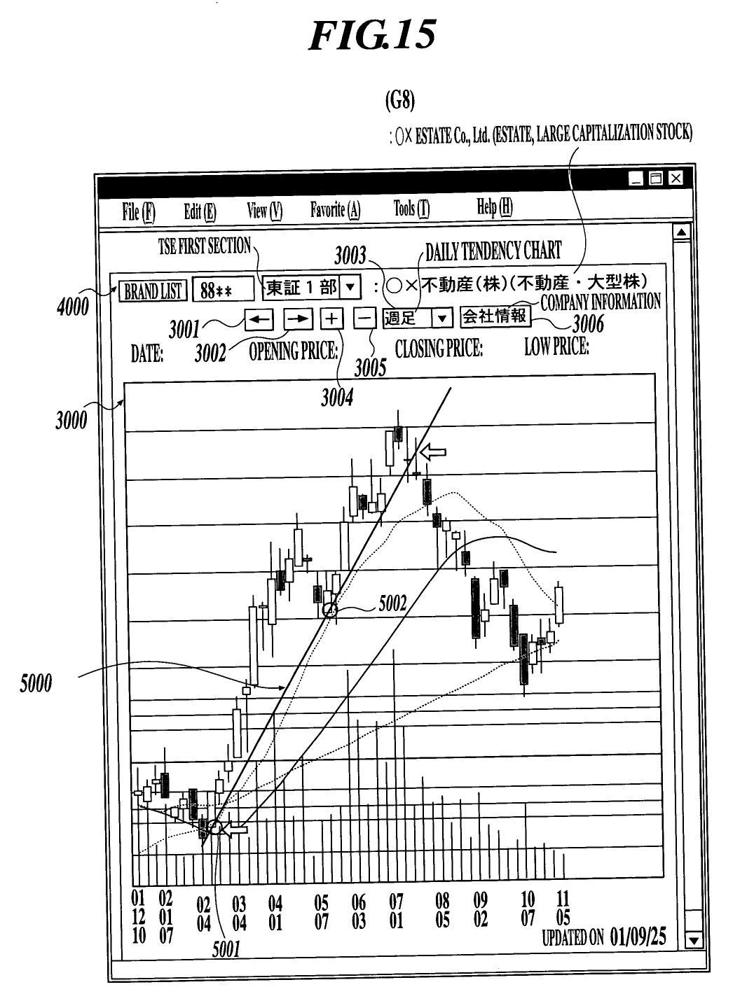

The upward trend line is a line which connects, for example, the lowest opening price among positive bar lines with the opening price of a positive bar line of a candlestick in a weekly candlestick-shaped tendency chart so as to have the smallest ascending angle. In other words, for example, as shown in a weekly tendency chart (G8) in FIG. 15, an upward trend line 5000 connecting an opening price 5001 of the positive bar line of the candlestick for the second week of February 2002 with an opening price 5002 of the positive bar line of the candlestick for the second week of May 2002 is drawn.

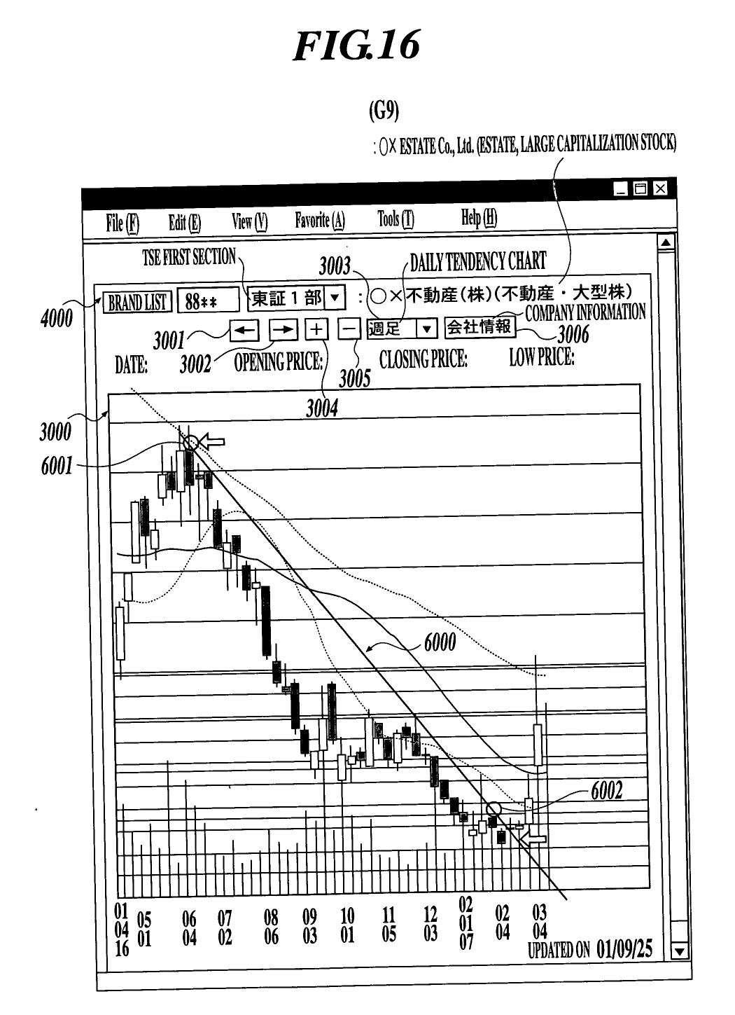

In contrast, the downward trend line is a line which connects, for example, the highest opening price among negative bar lines with the opening price of a negative bar line of a candlestick in a weekly candlestick-shaped tendency chart so as to have the smallest descending angle. In other words, for example, as shown in a weekly tendency chart (G9) in FIG. 16, a downward trend line 6000 connecting an opening price 6001 of the negative bar line of the candlestick for the second week of June 2001 with an opening price 6002 of the negative bar line of the candlestick for the fourth week of January 2002 is drawn.

Thereafter, based on the upward trend line or the downward trend line drawn in Step S404, and on the data of the negative bar line or the positive bar line of the candlestick with a buy signal or a sell signal, the CPU 21 judges whether the brand is in a buy-turn or a sell-turn (Step S405).

More specifically, when a negative bar line of a candlestick with a sell signal is below the upward trend line, the CPU 21 judges that the brand is in a sell-turn. For example, as shown in FIG. 15, when a sell signal is shown in the fourth week of July 2002, the negative bar line of the candlestick is below the upward trend line, and the CPU 21 therefore judges that the brand is in a sell-turn.

When a candlestick with a buy signal is above a downward trend line, the CPU 21 judges that the brand is in a buy-turn. For example, as shown in FIG. 16, when a buy signal is shown in the third week of February 2002, the positive bar line of the candlestick is above the downward trend line, and the CPU 21 therefore judges that the brand is in a buy-turn.

Thereafter, the CPU 21 creates sell-turn or buy-turn information which is the result of the judgment in Step S405 (Step S406), and transmits the information to the user terminal 3 through the communication control unit 27 (Step S407).

The communication control unit 37 of the user terminal 3 receives the sell-turn or buy-turn information (Step S408), and the CPU 31 displays the received sell-turn or buy-turn information on the display unit 33 (Step S409), thus completing the processing.

In this way, judgment is automatically performed on whether promising brand(s) are in a sell-turn or a buy-turn or not, and the buy-turn/sell-turn information is notified to the user terminal. Therefore, even a user who is not accustomed to stock trading can easily recognize a sell-turn.

It should be noted that the present invention is not limited to the embodiment described above, and it should be understood that various changes and modifications can be made therein.

For example, the stock trading support apparatus 2 may be of a stand-alone type provided in a securities company or the like, without connection to a communication line, to supply stock information only to customers who come to the company.

Moreover, in addition to supplying stock information, the stock trading support apparatus may be capable of executing actual stock trading processing. Alternatively, the stock trading support apparatus 2 may be connectable to the online trade server or the like of a securities company, to allow a user terminal 3 to be connected to the online trade server when a stock trading request command on an arbitrary brand is transmitted from the user terminal 3. This is useful in terms of that the distributed stock price information is more directly linked to the actual stock trading.

Further, for example, the criteria items for searching for brands are not limited to those described above, as long as the items include evaluation items such as evaluation for buying and selling. In addition, the above-described judgment processing on judging whether the brand is in a good time to buy or sell is performed based on a key-shaped tendency chart; however, the processing is not limited thereto.

Furthermore, the stock information to be supplied to users is not limited to the above. For example, the charts are not limited to the key-shaped tendency chart and the candlestick-shaped tendency chart.

### INDUSTRIAL APPLICABILITY

The present invention is applicable not only to a securities industry which handles stock trading, but to an information services industry, an information system industry, and the like.

1. A stock trading support apparatus to support stock trading, comprising:
a stock price analysis information creating section to create stock price analysis information by analyzing a stock price of each brand based on stock price information;
a promising brand information creating section to create promising brand information by judging whether the each brand is in a good time to buy or sell based on the stock price analysis information created by the stock price analysis information creating section; and
an output section to output stock information containing the stock price analysis information and the promising brand information.

2. The stock trading support apparatus as claimed in claim 1, which is connectable to a user terminal through a communication network, and further comprises a stock information transmitting section to transmit the stock information to the user terminal device.

3. The stock trading support apparatus as claimed in claim 2, further comprising:
a receiving section to receive from the user terminal a search criterion for searching for promising brand information;
a promising brand information search section to search for promising brand information relevant to the search criterion received by the receiving section; and
a transmitting section to transmit to the user terminal the promising brand information retrieved by the promising brand information search section.

4. The stock trading support apparatus as claimed in claim 3, wherein the search criterion includes at least one of a stock type, a buy-timing or a sell-timing of a brand, a price bracket, a peak price zone or a bottom price zone of a stock price, a high price zone or a low price zone of a stock price, and a scale.

5. The stock trading support apparatus as claimed in claim 2, further comprising:
a registration section to register a search criterion for searching for promising brand information, which is transmitted from the user terminal;
a search section to periodically search whether there is promising brand information relevant to the search criterion registered by the registration section; and
a notifying section to notify, when promising brand information relevant to the search criterion is retrieved by the search section, the retrieved promising brand information to the user terminal.

6. The stock trading support apparatus as claimed in claim 1, wherein the stock price analysis information includes a key-shaped tendency chart.

7. The stock trading support apparatus as claimed in any one of claims 1 to 6, wherein the stock price analysis information includes a candlestick-shaped tendency chart, the apparatus further comprising:
a line-drawing section to draw a downward trend line based on the candlestick-shaped tendency chart of a brand judged to be in a good time to buy, among brands in the promising brand information created by the promising brand information creating section;
a judging section to judge whether the brand is in a buy-turn, based on the downward trend line drawn by the line-drawing section and on candlestick-shaped tendency chart data at the good time to buy the brand judged to be in the good time to buy; and
a buy-turn information notifying section to notify the user terminal of a judgment result given by the judging section, as buy-turn information.

8. The stock trading support apparatus as claimed in any one of claims 1 to 6, wherein the stock price analysis information includes a candlestick-shaped tendency chart, the apparatus further comprising:
a line-drawing section to draw a upward trend line based on the candlestick-shaped tendency chart of a brand judged to be in a good time to sell, among brands in the promising brand information created by the promising brand information creating section;
a judging section to judge whether the brand is in a sell-turn, based on the upward trend line drawn by the line-drawing section and on candlestick-shaped tendency chart data at the good time to sell the brand judged to be in the good time to sell; and
a sell-turn information notifying section to notify the user terminal of a judgment result given by the judging section, as sell-turn information.

9. A stock trading support system where a stock trading support apparatus to support stock trading is connected to a user terminal through a communication network, wherein the stock trading support apparatus comprises:
a stock price analysis information creating section to create stock price analysis information by analyzing a stock price of each brand based on stock price information;
a promising brand information creating section to create promising brand information by judging whether the each brand is in a good time to buy or sell based on the stock price analysis information created by the stock price analysis information creating section;
a receiving section to receive from the user terminal a search criterion for searching for promising brand information;
a promising brand information search section to search for promising brand information relevant to the search criterion received by the receiving section; and
a transmitting section to transmit to the user terminal the promising brand information retrieved by the promising brand information search section,
and the user terminal comprises:
an input section to input the search criterion;
a communication section to transmit, to the stock trading support apparatus, the search criterion inputted through the input section, and receive the promising brand information transmitted by the transmitting section; and
an output section to output the promising brand information received by the communication section.
